(19) United States
(12) Patent Application Publication
(10) Pub. No.: US 2022/0341079 A1
(43) Pub. Date: Oct. 27, 2022

(54) METHOD FOR IMPROVED TUMBLING OF CLOTHES IN A WASHING MACHINE APPLIANCE

(71) Applicant: Haier US Appliance Solutions, Inc., Wilmington, DE (US)

(72) Inventors: Khalid Jamal Mashal, Louisville, KY (US); Gregory Allen Dedow, Louisville, KY (US); Aaron Lee Welch, Louisville, KY (US)

(21) Appl. No.: 17/236,111

(22) Filed: Apr. 21, 2021

(51) Int. Cl. D06F 34/18; D06F 39/14; D06F 33/36; D06F 23/02; H04N 7/18; G06K 9/00

(52) U.S. Cl. CPC D06F 34/18; D06F 39/14; D06F 33/36; D06F 23/02; H04N 7/18; G06K 9/00624; D06F 2105/48

(57) ABSTRACT

A method of operating a washing appliance includes obtaining images of a wash chamber using a camera assembly while the wash basket is tumbling a load of clothes positioned therein. The one or more images are analyzed using a machine learning image recognition process to determine a tumble condition of the load of clothes in the wash basket, e.g., whether the clothes are tumbling in the wash basket in a manner that generates suitable mechanical washing action. The motor assembly is then used to adjust a basket speed based at least in part on determining that the tumble condition deviates from a target tumble condition.

### FIELD OF THE INVENTION

The present subject matter relates generally washing machine appliances, or more specifically, to systems and methods of using camera assemblies to monitor and correct tumbling conditions within a washing machine appliance.

### BACKGROUND OF THE INVENTION

Washing machine appliances generally include a wash tub for containing water or wash fluid, e.g., water and detergent, bleach, and/or other wash additives. A wash basket is rotatably mounted within the wash tub and defines a wash chamber for receipt of articles for washing. During normal operation of such washing machine appliances, the wash fluid is directed into the wash tub and onto articles within the wash chamber of the wash basket. A drive assembly is coupled to the wash tub and is configured to selectively rotate the wash basket within the wash tub at various speeds to tumble and agitate articles within the wash chamber. During a spin or drain cycle of a washing machine appliance, a drain pump assembly may operate to discharge water from within sump.

Notably, during a wash or agitation cycle of a washing machine appliance, the optimal wash basket spin speed, sequence, or profile for tumbling clothes and imparting desirable agitation or mechanical washing action may vary based on a variety of factors, such as cloth type, load size, wash fluid level, etc. However, conventional washing machine appliances have fixed tumbling or spin speeds for a wash basket, regardless of the particularities of the load of clothes or other operating parameters of a wash cycle.

Accordingly, improved systems and methods for implementing wash cycles in washing machine appliances are desired. In particular, systems and methods which provide accurate and improved spin speeds for improved agitation performance would be advantageous.

### BRIEF DESCRIPTION OF THE INVENTION

Advantages of the invention will be set forth in part in the following description, or may be apparent from the description, or may be learned through practice of the invention.

In one exemplary embodiment, a washing machine appliance is provided including a wash tub positioned within a cabinet, a wash basket rotatably mounted within the wash tub and defining a wash chamber configured for receiving a load of clothes, a motor assembly operably coupled to the wash basket for selectively rotating the wash basket, a camera assembly mounted within the cabinet in view of the wash chamber, and a controller operably coupled to the motor assembly and the camera assembly. The controller is configured to operate the motor assembly to rotate the wash basket and tumble the load of clothes, obtain one or more images of the wash chamber using the camera assembly, analyze the one or more images using a machine learning image recognition process to determine a tumble condition of the load of clothes in the wash basket, determine that the tumble condition deviates from a target tumble condition, and operate the motor assembly to adjust a basket speed based at least in part on determining that the tumble condition deviates from the target tumble condition.

In another exemplary embodiment, a method of operating a washing appliance is provided. The washing appliance includes a wash basket rotatably mounted within a wash tub and defining a wash chamber configured for receiving a load of clothes, a motor assembly operably coupled to the wash basket for selectively rotating the wash basket, and a camera assembly mounted within the cabinet in view of the wash chamber. The method includes operating the motor assembly to rotate the wash basket and tumble the load of clothes, obtaining one or more images of the wash chamber using the camera assembly, analyzing the one or more images using a machine learning image recognition process to determine a tumble condition of the load of clothes in the wash basket, determining that the tumble condition deviates from a target tumble condition; and operating the motor assembly to adjust a basket speed based at least in part on determining that the tumble condition deviates from the target tumble condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary washing machine appliance according to an exemplary embodiment of the present subject matter.

FIG. 2 provides a side cross-sectional view of the exemplary washing machine appliance of FIG. 1.

FIG. 3 provides a cross-sectional view of the exemplary washing machine appliance of FIG. 1 with a camera assembly mounted on a door according to an exemplary embodiment of the present subject matter.

FIG. 4 provides a schematic view of a door and gasket sealed against a cabinet of the exemplary washing machine of FIG. 1, along with a camera mounted within the gasket according to an exemplary embodiment of the present subject matter.

FIG. 5 illustrates a method for operating a washing machine appliance in accordance with one embodiment of the present disclosure.

FIG. 6 provides a flow diagram illustrating an exemplary process for implementing a tumble monitoring process according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

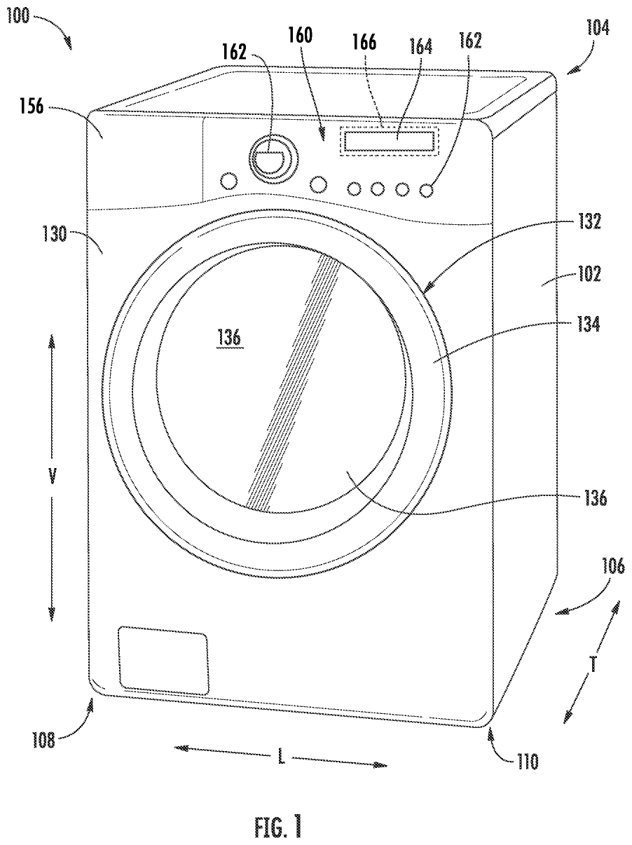

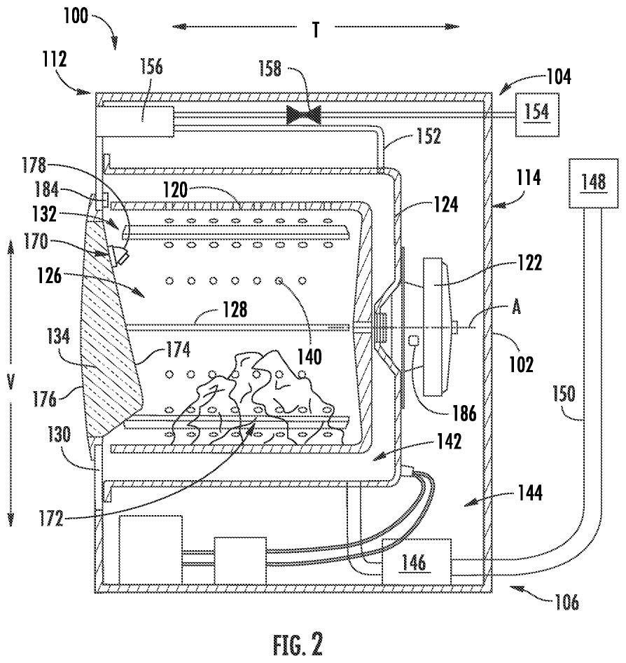

Referring now to the figures, an exemplary laundry appliance that may be used to implement aspects of the present subject matter will be described. Specifically, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined.

According to exemplary embodiments, washing machine appliance 100 includes a cabinet 102 that is generally configured for containing and/or supporting various components of washing machine appliance 100 and which may also define one or more internal chambers or compartments of washing machine appliance 100. In this regard, as used herein, the terms “cabinet,” “housing,” and the like are generally intended to refer to an outer frame or support structure for washing machine appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of washing machine appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing washing machine appliance 100.

Referring to FIG. 2, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present subject matter.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users. Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through opening 132, and washing operation is initiated through operator manipulation of input selectors 162. Wash tub 124 is filled with water, detergent, and/or other fluid additives, e.g., via spout 152 and/or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

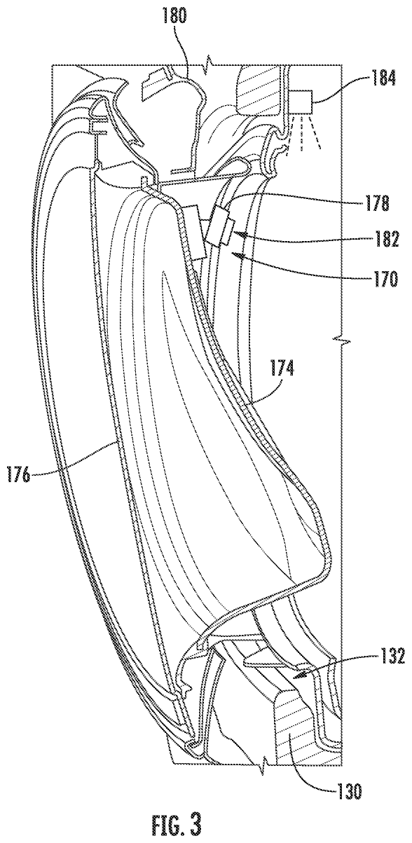

Referring now specifically to FIGS. 2 and 3, washing machine appliance 100 may further include a camera assembly 170 that is generally positioned and configured for obtaining images of wash chamber 126 or a load of clothes (e.g., as identified schematically by reference numeral 172) within wash chamber 126 of washing machine appliance 100. Specifically, according to the illustrated embodiment, door 134 of washing machine appliance 100 comprises and inner window 174 that partially defines wash chamber 126 and an outer window 176 that is exposed to the ambient environment. According to the illustrated exemplary embodiment, camera assembly 170 includes a camera 178 that is mounted to inner window 174. Specifically, camera 178 is mounted such that is faces toward a bottom side of wash tub 124. In this manner, camera 178 can take images or video of an inside of wash chamber 126 and remains unobstructed by windows that may obscure or distort such images.

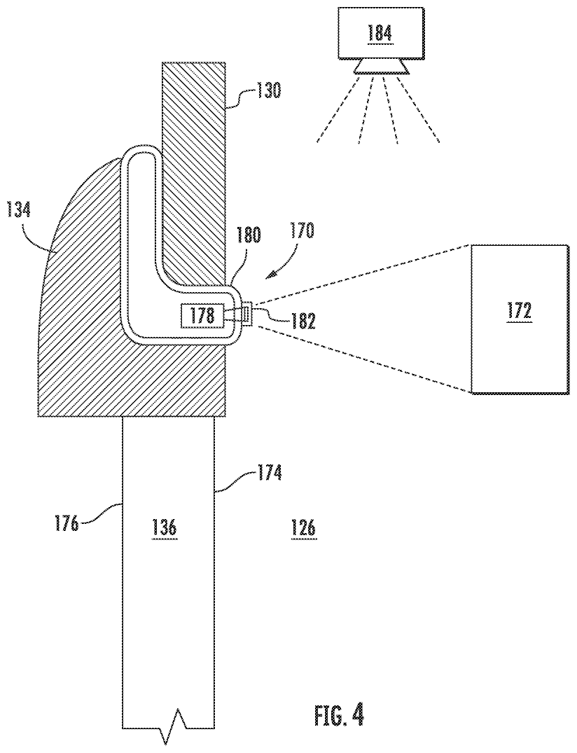

Referring now briefly to FIG. 4, another installation of camera assembly 170 will be described according to an exemplary embodiment of the present subject matter. Due to the similarity between this and other embodiments, like reference numerals may be used to refer to the same or similar features. According to this exemplary embodiment, camera assembly 170 is mounted within a gasket 180 that is positioned between a front panel 130 of cabinet 102 and door 134. Although exemplary camera assemblies 170 are illustrated and described herein, it should be appreciated that according to alternative embodiments, washing machine appliance 100 may include any other camera or system of imaging devices for obtaining images of the load of clothes 172.

It should be appreciated that camera assembly 170 may include any suitable number, type, size, and configuration of camera(s) 178 for obtaining images of wash chamber 126. In general, cameras 178 may include a lens 182 that is constructed from a clear hydrophobic material or which may otherwise be positioned behind a hydrophobic clear lens. So positioned, camera assembly 170 may obtain one or more images or videos of clothes 172 within wash chamber 126, as described in more detail below. Referring still to FIGS. 2 through 4, washing machine appliance 100 may further include a tub light 184 that is positioned within cabinet 102 or wash chamber 126 for selectively illuminating wash chamber 126 and/or the load of clothes 172 positioned therein. It should be appreciated that according to exemplary embodiments, tub light 184 may be integrated into camera assembly 170.

According to exemplary embodiments of the present subject matter, washing machine appliance 100 may further include a basket speed sensor 186 (FIG. 2) that is generally configured for determining a basket speed of wash basket 120. In this regard, for example, basket speed sensor 186 may be an optical, tactile, or electromagnetic speed sensor that measures a motor shaft speed (e.g., such as a tachometer, hall-effect sensor, etc.). According to still other embodiments, basket speeds may be determined by measuring a motor frequency, a back electromotive force (EMF) on motor 122, or a motor shaft speed in any other suitable manner. Accordingly, it should be appreciated that according to exemplary embodiments, a physical basket speed sensor 186 is not needed, as electromotive force and motor frequency may be determined by controller 166 without needing a physical speed sensor. It should be appreciated that other systems and methods for monitoring basket speeds may be used while remaining within the scope of the present subject matter.

Notably, controller 166 of washing machine appliance 100 (or any other suitable dedicated controller) may be communicatively coupled to camera assembly 170, tub light 184, basket speed sensor 186, and other components of washing machine appliance 100. As explained in more detail below, controller 166 may be programmed or configured for obtaining images using camera assembly 170, e.g., in order to detect certain operating conditions and improve the performance of washing machine appliance. In addition, controller 166 may be programmed or configured to perform methods to monitor tumbling conditions using images obtained by camera assembly 170 and implement corrective action, thereby improving performance of washing machine appliance 100.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances. In addition, aspects of the present subject matter may be utilized in a combination washer/dryer appliance. Indeed, it should be appreciated that aspects of the present subject matter may further apply to other laundry appliances, such as combination washers/dryers, dryer appliances, etc.

Now that the construction of washing machine appliance 100 and the configuration of controller 166 according to exemplary embodiments have been presented, an exemplary method 200 of operating a washing machine appliance will be described. Although the discussion below refers to the exemplary method 200 of operating washing machine appliance 100, one skilled in the art will appreciate that the exemplary method 200 is applicable to the operation of a variety of other washing machine appliances, such as vertical axis washing machine appliances. In exemplary embodiments, the various method steps as disclosed herein may be performed by controller 166 or a separate, dedicated controller.

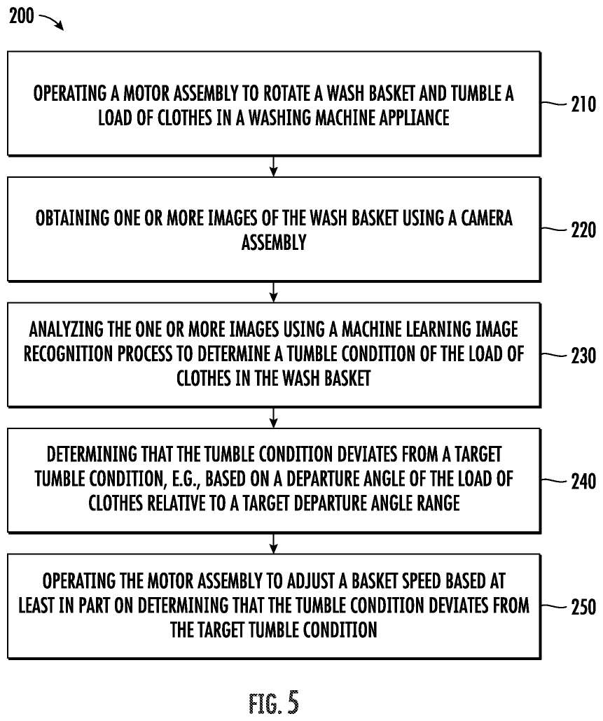

Referring now to FIG. 5, method 200 includes, at step 210, operating a motor assembly to rotate a wash basket and tumble a load of clothes in a washing machine appliance. In this regard, continuing the example from above, motor 122 may be used rotate wash basket 120 within washing machine appliance 100 to facilitate a washing or agitation cycle. Notably, as explained briefly above, proper agitation and/or mechanical action must be imparted on the load of clothes within wash basket 120 to achieve effective and desired cleaning performance. In addition, the mechanical action imparted on a load of clothes is highly dependent on a basket speed of wash basket 120. However, conventional washing machine appliances operate at a single spin speed during the agitation cycle regardless of size of the load, the type of load, etc. As such, aspects of the present subject matter are directed to methods for spinning a wash basket at a desired basket speed during an agitation cycle to account for variations and load and wash cycle parameters.

The agitation cycle may begin by spinning wash basket 120 at an initial spin speed. For example, step 210 may include tumbling the load of clothes at a predetermined speed that is set by the manufacturer, programmed by the user, or determined in some other suitable manner. Alternatively, motor 122 may slowly increase the speed of wash basket 120 until the load of clothes 172 positioned therein begin tumbling and the remaining steps of method 200 may be performed. Specifically, the remaining steps of method 200 may be directed towards methods for intelligently and automatically moderating or adjusting the spin speed of the wash basket, e.g., to ensure that the basket speed achieves desired agitation performance and improves user satisfaction regarding the performance of washing machine appliance 100.

Specifically, step 220 may include obtaining one or more images of the wash basket or the wash chamber using a camera assembly. For example, continuing the example from above, camera assembly 170 may capture images of wash chamber 126 of washing machine appliance 100. As explained in more detail below, these images may be used to determine a tumble condition of clothes 172 within wash chamber 126 in order to assess whether appropriate agitation and wash performance is being achieved. Exemplary tumble conditions and associated analysis will be described in more detail below. By identifying undesirable tumbling conditions during an agitation cycle, corrective action may be taken for improved tumbling, agitation, and wash performance.

According to exemplary embodiments of the present subject matter, a frame rate of camera assembly 170 may be set such that it is related to or associated with the basket speed (e.g., as determined using basket speed sensor 186 or any other suitable means). For example, according to exemplary embodiments, the frame rate may be proportional to the basket speed or substantially equivalent to the basket speed. For example, the frame rate may be selected as having any suitable proportional relationship to the basket speed, where the proportionality is selected to achieve improved accuracy of detecting the tumble condition.

As used herein, the terms “frame rate” and similar terms are intended generally to refer to the number of images taken by camera assembly 170 within a given time period. For example, the frame rate may be the number of individual frames obtained by camera assembly 170 within a single second, often referred to as frames per second (or “FPS”). Although the discussion herein refers to having a frame rate that is proportional to or equivalent to the basket speed, it should be appreciated that absolute equivalence or a direct proportional relationship is not strictly necessary and that aspects of the present subject matter may be implemented with slight differences between the measured basket speed and the frame rate in accordance with some specific proportional relationship.

The present disclosure generally refers to maintaining a frame rate that is proportional to or equivalent to the basket speed. However, it should be appreciated that any suitable conversions as to the measured variables and their frequency of capture may be used according to exemplary embodiments. Indeed, controller 166 and/or camera assembly 170 may generally be configured for making any suitable adjustment to the frame rate of camera assembly 170 such that it corresponds to the basket speed or some proportion thereof. Notably, when the frame rate and basket speed are synced in this manner, the resulting video or series of images may have less distortion or blur and may generally provide a better video representation or snapshot of the load of clothes 172 within wash chamber 126. For example, this may be due to the fact that each frame captured by camera assembly 170 shows wash basket 120 at the same angular position. However, it should be appreciated that according to alternative embodiments, the images obtained at step 220 may be captured independent of the basket speed. In this regard, while adjusting the frame rate of camera assembly 170 to match the basket speed may improve the clarity of images obtained, aspects of the present subject matter may be used to identify tumble conditions using images or video obtained when the frame rate of the camera assembly does not match the basket speed.

Thus, step 220 includes obtaining a series of frames or a video of the load of clothes 172 within wash chamber 126. For example, camera assembly 170 may obtain a video clip of the wash basket while it is rotating at the basket speed and the frame rate of the video clip is taken at the basket speed. Step 220 may include taking a still image from the video clip or otherwise obtaining a still representation or photo from the video clip. It should be appreciated that the images obtained by camera assembly 170 may vary in number, frequency, angle, resolution, detail, etc. in order to improve the clarity of the load of clothes 172. In addition, according to exemplary embodiments, controller 166 may be configured for illuminating the tub using tub light 184 just prior to obtaining images.

Referring still to FIG. 5, method 200 may include, at step 230, analyzing the one or more images using a machine learning image recognition process to determine a tumble condition of the load of clothes in the wash basket. It should be appreciated that any suitable image processing or recognition method may be used to analyze the images obtained at step 220 and facilitate determination of the tumble condition. In addition, it should be appreciated that this image analysis or processing may be performed locally (e.g., by controller 166) or remotely (e.g., by a remote server).

As used herein, the term “tumble condition” is generally intended to refer to any suitable qualitative or quantitative measure or assessment of the performance of an agitation or wash cycle. For example, the tumble condition may refer to an average departure angle where the load of clothes depart from the wash basket (e.g., such as the point where gravitational pull tends to overcome the centrifugal force exerted on the clothes as the basket spins). In addition, or alternatively, the tumble condition may refer to a common path, track, or profile the clothes take while passing within wash basket or may refer to any other representative information of a tumbling condition or tumbling parameters. In addition, it should be appreciated that the “target” tumble condition (in contrast to the “actual” tumble condition, or just the “tumble condition”) generally refers to a tumble profile or tumble condition that is optimal or otherwise desired for a particular load of clothes, e.g., based on the load size, load type, detergent and wash fluid levels, etc. Exemplary embodiments of the target tumble condition will be described below in more detail with respect to step 240.

According to exemplary embodiments of the present subject matter, step 230 of analyzing the one or more images may include analyzing the image(s) of the wash chamber using a neural network classification module and/or a machine learning image recognition process. In this regard, for example, controller 166 may be programmed to implement the machine learning image recognition process that includes a neural network trained with a plurality of images of baskets with different tumble conditions or profiles. By analyzing the image(s) obtained at step 220 using this machine learning image recognition process, controller 166 may determine or identify the tumble profile and may facilitate determination of spin speed adjustments, e.g., by identifying the trained image that is closest to the obtained image.

As used herein, the terms image recognition process and similar terms may be used generally to refer to any suitable method of observation, analysis, image decomposition, feature extraction, image classification, etc. of one or more images or videos taken within a wash chamber of a washing machine appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by camera assembly 170 and controller 166 may be programmed to perform such processes and take corrective action.

According to an exemplary embodiment, controller may implement a form of image recognition called region based convolutional neural network (“R-CNN”) image recognition. Generally speaking, R-CNN may include taking an input image and extracting region proposals that include a potential object, such as a particular garment or region of a load of clothes. In this regard, a “region proposal” may be regions in an image that could belong to a particular object, such as a particular article of clothing or the wash basket. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like.

According to still other embodiments, the image recognition process may use any other suitable neural network process. For example, step 220 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image to determine a tumble condition within wash basket 120. In addition, a K-means algorithm may be used. Other image recognition processes are possible and within the scope of the present subject matter.

It should be appreciated that any other suitable image recognition process may be used while remaining within the scope of the present subject matter. For example, step 220 may include using a deep belief network (“DBN”) image recognition process. A DBN image recognition process may generally include stacking many individual unsupervised networks that use each network's hidden layer as the input for the next layer. According to still other embodiments, step 220 may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence (“AI”) analysis techniques, and combinations of the above described or other known methods may be used while remaining within the scope of the present subject matter.

Step 240 may include determining that the tumble condition deviates from a target tumble condition. In this regard, for example, the tumble condition identified at step 230 may be compared to an optimal, preferred, or target tumble condition. Deviations from the target tumble condition may indicate room for improvement in the tumble process. Specifically, for example, increasing or decreasing the speed may adjust the actual tumble condition toward the target tumble condition for improved mechanical agitation and performance of washing machine appliance 100.

As used herein, the “target” tumble condition may generally refer to the preferred, desired, or optimal tumble condition or profile for a particular load of clothes in a particular washing machine appliance. It should be appreciated that the target tumble condition may depend in large part based on a load size, a load type, or other quantitative or qualitative aspects of load of clothes 172 or the washing machine appliance performing the tumbling. For example, if the load size is small and contains lightweight and delicate garments, the spin speed may be lower to achieve the desired tumble condition. By contrast, if the load size is large and contains heavy blankets or cotton towels, spin speed may be raised to achieve the desired tumble condition.

The target tumble condition may be based on any suitable qualitative or quantitative metric related to the performance of a washing machine cycle or the tumble cycle being performed. For example, according to an exemplary embodiment, the tumble condition may be based on a departure angle of the load of clothes as they tumble within wash basket 120. In general, the departure angle may refer to the angular position on wash basket 120 where the majority or average amount of clothes departs or separate from wash basket 120, e.g., under the force of gravity.

As used herein, the “clock position” may be used to identify a circumferential portion of wash basket 120, e.g., particularly with respect to the departure angle of a load of clothes. In this regard, the clock position is the relative direction of a portion of wash basket 120 described using the analogy of a 12-hour clock. In addition, the clock position is based on a view of a user from front 112 of washing machine appliance 100. Thus, for example, 12 o'clock means the highest point of wash basket 120 along the vertical direction V, 3 o'clock means the far right portion of wash basket 120 along the lateral direction L, 6 o'clock means the lowest point of wash basket 120 along the vertical direction V, and 9 o'clock means the far left portion of wash basket 120 along the lateral direction L. In addition, the clockwise and counterclockwise directions of rotation of wash basket 120 are intended to refer to the direction of rotation about a rotational axis of wash basket 120 when viewed by a user from front 112 of washing machine appliance 100.

In addition, the term “departure angle” and the like is intended to refer generally to the circumferential position on wash basket 120 where clothes 172 begin tumbling, rolling off, or departing from wash basket 120 under the force of gravity. In general, lower basket speeds result in a departure angle that is lower along the vertical direction V, e.g., such as between about 4 o'clock and 8 o'clock (depending on whether rotation is clockwise or counterclockwise). By contrast, higher basket speeds result in a departure angle that is higher along the vertical direction V, e.g., such as between about 10 o'clock and 2 o'clock (depending on whether rotation is clockwise or counterclockwise). At even higher speeds, the centrifugal force may be so high that some or all clothes 172 become plastered and have no departure angle at all. Thus, for example, a 9 o'clock departure angle of load of clothes 172 refers to a condition where the average point where clothes fall from wash basket 120 during the tumbling process is at the left-most region of wash basket, or the 9 o'clock position.

According to exemplary embodiments, step 240 of determining that a tumble condition deviates from the target tumble condition may include determining that the load of clothes in the wash basket tumbles with an average basket departure angle that is outside of the target departure angle range. For example, according to exemplary embodiments, the target departure angle range may be between about 9 o'clock and 3 o'clock, between about 10 o'clock and 2 o'clock, between about 11 o'clock and 1 o'clock, etc. More specifically, the target departure angle range may vary depending on whether wash basket 120 is rotating in the clockwise direction or the counterclockwise direction. For example, when the wash basket is rotating in the clockwise direction, a target departure angle may be the 11 o'clock position and the target departure angle range may be between about 10 o'clock and 12 o'clock (i.e., a suitable range surrounding the target departure angle). By contrast, when the wash basket is rotating in the counterclockwise direction, a target departure angle may be the 1 o'clock position and the target departure angle range may be between about 2 o'clock and 12 o'clock. It should be appreciated that these departure angle ranges are only exemplary and are not intended to limit the scope of the present subject matter in any manner. In addition, it should be appreciated the ranges may be broader or narrower, the actual departure angle may be an average departure angle for all items of clothing, and the deviation from the target tumble condition may be determined in any other suitable manner.

Step 250 may generally include operating the motor assembly to adjust a basket speed based at least in part on determining that the tumble condition deviates from the target tumble condition. In this regard, for example, motor 122 may be used to increase or decrease the spin speed of wash basket 120 based in part on the comparison of the actual tumble condition (e.g., determined at step 230) as compared to the target tumble condition (e.g., as described at step 240). In this regard, for example, if the target tumble condition includes a tumble profile where the load of clothes departs from the wash basket at approximately 11 o'clock position (in CW direction) and the clothes are actually departing at 9 o'clock position, controller 166 may increase the spin speed such that the centrifugal force maintains engagement between the load of clothes 172 and wash basket 120 for a longer time (e.g., such that the clothes may have a departure angle closer to 11 o'clock position).

According to exemplary embodiments, adjusting the basket speed based at least in part on determining that a tumble condition deviates from the target tumble condition may include increasing the basket speed when an average basket departure angle is between about 6 o'clock and 10 o'clock (when the basket is rotating in the clockwise direction) or between about 6 o'clock and 2 o'clock positions (when basket is rotating in the counterclockwise direction). In addition, adjusting the basket speed may include decreasing the basket speed when the average basket departure angle is between about 12 o'clock position and a 2 o'clock position (when the wash basket is rotating in a clockwise direction) or between the 12 o'clock and a 10 o'clock position (when the wash basket is rotating in a counterclockwise direction).

In addition, according to exemplary embodiments, the analysis performed at 230 may be used to identify the presence of one or more plastered or fixed articles of clothing on wash basket 120. Notably, according to exemplary embodiments, if one or more articles of clothing are plastered to wash basket 120, it may be desirable to slow the wash basket at least temporarily to permit the article to begin tumbling with the rest of the load. After the plastered or fixed articles of clothing joins the remainder of the load of clothes, the decreased spin speed may be maintained or the spin speed may once again be increased in accordance with the methods described herein.

Notably, method 300 may further include determining that tumble condition is equal to or substantially equal to the target tumble condition. In this regard, the tumbling of clothes within the wash basket is suitably close to the target tumble condition (e.g., such that the actual departure angle is close to the target departure angle), controller may be configured to operate the motor assembly to maintain the basket speed for the duration of the agitation cycle. It should be appreciated that other variations and modifications may be made to method 200 while remaining within the scope the present subject matter.

It should be appreciated that other suitable metrics for determining or analyzing the tumble conditions may be used. In this regard, for example, the target tumble condition may be represented by an average “tumble line” or “tumble path.” In this regard, for example, when the wash basket 120 is rotating in the clockwise direction, the target tumble condition may be departure of the clothes at the 11 o'clock position and re-engagement of the clothes and the wash basket at the 4 or 5 o'clock position. According to exemplary embodiments, an imaginary line or arcuate path may be defined between the departure and re-engagement positions. As long as the clothes fall or tumble primarily along the that line (e.g., the “tumble line”), method 200 may include determining that the basket tumble speed is ideal. By contrast, if the clothes tend to fall primarily below the tumble line or above the tumble line, method 200 may include determining that the spin speed is too low or too high, respectively. Other manners of assessing tumble performance are possible and are deemed within the scope of the present subject matter.

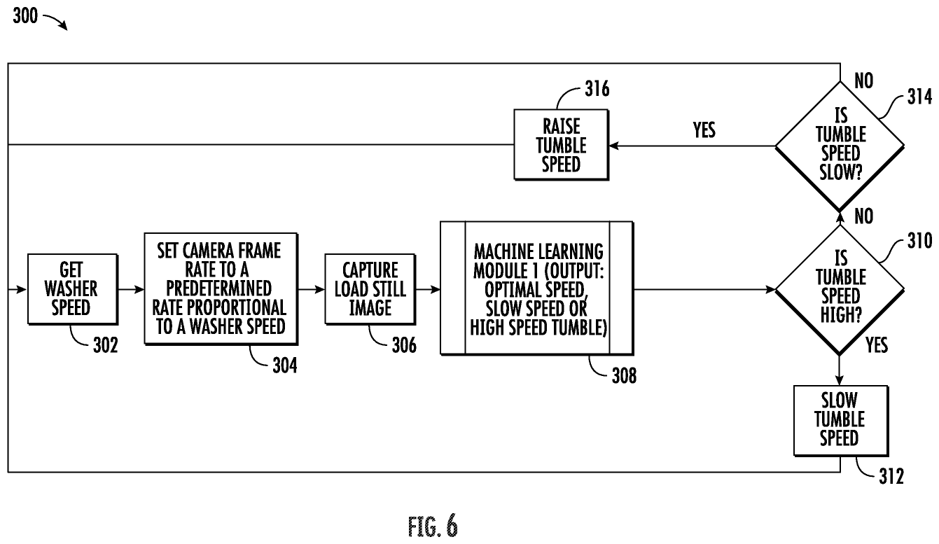

Referring now briefly to FIG. 6, an exemplary flow diagram of a tumbling the assistance method 300 that may be implemented by washing machine appliance 100 will be described according to an exemplary embodiment of the present subject matter. According to exemplary embodiments, method 300 may be similar to or interchangeable with method 200 and may be implemented by controller 166 of washing machine appliance 100. As shown, at step 302, controller 166 may first obtain a basket speed of the wash basket. Step 304 may include setting a frame rate of the camera assembly to a predetermined rate proportional to or equal to the wash basket speed. In this manner, as described above, camera assembly 170 may obtain improved or clarified images of wash basket 120 and the clothes 172 tumbling therein. Alternatively, it should be appreciated that method 300 may be performed while omitting steps 302 and 304 such that the frame rate of the camera is not matched in any manner to the basket speed.

Step 306 includes capturing one or more images of the wash chamber using the camera assembly and step 308 includes implementing a machine learning module to determine a tumbling condition from the images obtained at step 306. In addition, according to exemplary embodiments, step 308 may otherwise include obtaining any suitable characterization of the tumble condition within wash basket 120. For example, step 308 may include a comparison of the images obtained at 306 with trained images associated with agitation cycles where the basket speed was at the desired or target speed, at a slow speed, at a high speed, etc. As such, a machine learning image recognition model can identify the tumbling condition.

At step 310, method 300 may include determining whether the tumble speed is high (e.g., based on the output from step 308). If the tumble speed is determined to be high, step 312 may include slowing the speed of the wash basket (e.g., using motor assembly 122). By contrast, if the tumble speed is not too high, step 314 may include determining whether the tumble speed is slow. If the tumble speed is determined to be slow at step 314, step 316 may include increasing the tumble speed (e.g., using motor 122). By contrast, if the tumble speed is determined not to be slow at step 314, and it has been determined not to be high at step 310, method 300 may conclude that the tumble speed is appropriate or equivalent to the target tumble speed. As such, the tumble monitoring process may continue at step 302 until it is determined that the tumble speed is too high or too low and corrective action may be taken.

FIGS. 5 and 6 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 and method 300 are explained using washing machine appliance 100 as an example, it should be appreciated that this method may be applied to the operation of any suitable laundry appliance, such as another washing machine appliance or a dryer appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance comprising:
a wash tub positioned within a cabinet;
a wash basket rotatably mounted within the wash tub and defining a wash chamber configured for receiving a load of clothes;
a motor assembly operably coupled to the wash basket for selectively rotating the wash basket;
a camera assembly mounted within the cabinet in view of the wash chamber; and
a controller operably coupled to the motor assembly and the camera assembly, the controller being configured to:
operate the motor assembly to rotate the wash basket and tumble the load of clothes;
obtain one or more images of the wash chamber using the camera assembly;
analyze the one or more images using a machine learning image recognition process to determine a tumble condition of the load of clothes in the wash basket;
determine that the tumble condition deviates from a target tumble condition; and
operate the motor assembly to adjust a basket speed based at least in part on determining that the tumble condition deviates from the target tumble condition.

2. The washing machine appliance of claim 1, wherein obtaining the one or more images comprises:
obtaining the basket speed of the wash basket; and
operating the camera assembly at a frame rate that is proportional to the basket speed while obtaining the one or more images.

3. The washing machine appliance of claim 1, wherein determining that the tumble condition deviates from the target tumble condition comprises:
determining that the load of clothes tumbles in the wash basket with an average basket departure angle outside of a target departure angle range.

4. The washing machine appliance of claim 3, wherein the target departure angle range is between about a 10 o'clock position and about a 2 o'clock position.

5. The washing machine appliance of claim 1, wherein operating the motor assembly to adjust the basket speed based at least in part on determining that the tumble condition deviates from the target tumble condition comprises:
increasing the basket speed of the wash basket when an average basket departure angle is between about a 6 o'clock position and about a 10 o'clock position when the wash basket is rotating in a clockwise direction or between about the 6 o'clock and about a 2 o'clock position when the wash basket is rotating in a counterclockwise direction.

6. The washing machine appliance of claim 1, wherein operating the motor assembly to adjust the basket speed based at least in part on determining that the tumble condition deviates from the target tumble condition comprises:
decreasing the basket speed of the wash basket when an average basket departure angle is between about a 12 o'clock position and about a 2 o'clock position when the wash basket is rotating in a clockwise direction or between about the 12 o'clock and about a 10 o'clock position when the wash basket is rotating in a counterclockwise direction.

7. The washing machine appliance of claim 1, wherein operating the motor assembly to adjust the basket speed based at least in part on determining that the tumble condition deviates from the target tumble condition comprises:
decreasing the basket speed of the wash basket when one or more articles of clothing are plastered to the wash basket.

8. The washing machine appliance of claim 1, wherein the controller is further configured to:
determine that the tumble condition equals the target tumble condition; and
operate the motor assembly to maintain the basket speed of the wash basket.

9. The washing machine appliance of claim 1, wherein the machine learning image recognition process comprises at least one of a convolution neural network (“CNN”), a region-based convolution neural network (“R-CNN”), a deep belief network (“DBN”), or a deep neural network (“DNN”) image recognition process.

10. The washing machine appliance of claim 1, further comprising:
a tub light for illuminating the wash chamber, wherein the controller is further configured to turn on the tub light prior to obtaining the one or more images of the wash chamber.

11. The washing machine appliance of claim 1, comprising:
a door rotatably mounted to the cabinet for providing selective access to the wash chamber; and
a gasket positioned between the door and the cabinet, wherein the camera assembly is mounted in the gasket or on an inner surface of the door.

12. A method of operating a washing appliance, the washing appliance comprising a wash basket rotatably mounted within a wash tub and defining a wash chamber configured for receiving a load of clothes, a motor assembly operably coupled to the wash basket for selectively rotating the wash basket, and a camera assembly mounted within the cabinet in view of the wash chamber, the method comprising:
operating the motor assembly to rotate the wash basket and tumble the load of clothes;
obtaining one or more images of the wash chamber using the camera assembly;
analyzing the one or more images using a machine learning image recognition process to determine a tumble condition of the load of clothes in the wash basket;
determining that the tumble condition deviates from a target tumble condition; and
operating the motor assembly to adjust a basket speed based at least in part on determining that the tumble condition deviates from the target tumble condition.

13. The method of claim 12, wherein obtaining the one or more images comprises:
obtaining the basket speed of the wash basket; and
operating the camera assembly at a frame rate that is proportional to the basket speed while obtaining the one or more images.

14. The method of claim 12, wherein determining that the tumble condition deviates from the target tumble condition comprises:
determining that the load of clothes tumbles in the wash basket with an average basket departure angle outside of a target departure angle range.

15. The method of claim 14, wherein the target departure angle range is between about a 10 o'clock position and about a 2 o'clock position.

16. The method of claim 12, wherein operating the motor assembly to adjust the basket speed based at least in part on determining that the tumble condition deviates from the target tumble condition comprises:
increasing the basket speed of the wash basket when an average basket departure angle is between about a 6 o'clock position and about a 10 o'clock position when the wash basket is rotating in a clockwise direction or between about the 6 o'clock and about a 2 o'clock position when the wash basket is rotating in a counterclockwise direction.

17. The method of claim 12, wherein operating the motor assembly to adjust the basket speed based at least in part on determining that the tumble condition deviates from the target tumble condition comprises:
decreasing the basket speed of the wash basket when an average basket departure angle is between about a 12 o'clock position and about a 2 o'clock position when the wash basket is rotating in a clockwise direction or between about the 12 o'clock and about a 10 o'clock position when the wash basket is rotating in a counterclockwise direction.

18. The method of claim 12, wherein operating the motor assembly to adjust the basket speed based at least in part on determining that the tumble condition deviates from the target tumble condition comprises:
decreasing the basket speed of the wash basket when one or more articles of clothing are plastered to the wash basket.

19. The method of claim 12, further comprising:
determining that the tumble condition equals the target tumble condition; and
operating the motor assembly to maintain the basket speed of the wash basket.

20. The method of claim 12, wherein the machine learning image recognition process comprises at least one of a convolution neural network (“CNN”), a region-based convolution neural network (“R-CNN”), a deep belief network (“DBN”), or a deep neural network (“DNN”) image recognition process.
